(19) United States
(12) Patent Application Publication
(10) Pub. No.: US 2014/0212553 A1
(43) Pub. Date: Jul. 31, 2014

(54) Sushi making apparatus

(71) Applicants: Marc Ouaknine, Lery (CA); Ouriel Ouaknine, Lery (CA)

(72) Inventors: Marc Ouaknine, Lery (CA); Ouriel Ouaknine, Lery (CA)

(21) Appl. No.: 13/752,802

(22) Filed: Jan. 29, 2013

(51) Int. Cl. A23P 1/08

(52) U.S. Cl. CPC A23P 1/086
USPC 426/231; 425/427

(57) ABSTRACT

A sushi making apparatus has a board member including a flat top surface, a pair of parallel elongated side walls, and an elongated cradle formed upon a first end portion perpendicular to the side walls. An elongated mat roller adapted to be placed within the cradle and having a length greater than the distance between the side walls. A mat member adapted to be placed upon the top surface of the board member in between the parallel side walls, one end of the mat member being removably attached to the mat roller along a length of the roller that is adapted to fit in between the parallel side walls, and an opposite end being removably attached to a second end portion of the board member that is opposite the first end portion and that is perpendicular to and in between the side walls.

### FIELD OF THE INVENTION

The present invention relates generally to food preparation devices but more particularly to the preparation of maki, also known as sushi.

### BACKGROUND OF THE INVENTION

Sushi is a very popular delicacy but sometimes, a lot of sushi has to be prepared quickly and the tools being used right now are not adequate for making perfectly and consistently made sushi at a fast pace. Moreover, there are no practical and efficient tools to help make it easier for people to make sushi at home. This instant inventor has filed patent application 20100297315 which solved many of those problems. However, recent improvements address the problems much better.

### SUMMARY OF THE INVENTION

In view of the foregoing disadvantages inherent in the known devices now present in the prior art, the present invention, which will be described subsequently in greater detail, is to provide objects and advantages which are:

To provide for an easy and convenient way of producing high quality sushi quickly.

Another advantage of this invention is to make it easier for people to make sushi at home.

In order to do so, the invention comprises:

a), a board member including a flat top surface, a pair of parallel elongated side walls, and an elongated cradle formed upon a first end portion perpendicular to the side walls. An elongated mat roller adapted to be placed within the cradle and having a length greater than the distance between the side walls, and handle portions formed upon opposite end portions that extend past the parallel side walls. A mat member adapted to be placed upon the top surface of the board member in between the parallel side walls, one end of the mat member being removably attached to the mat roller along a length of the roller that is adapted to fit in between the parallel side walls, and an opposite end being removably attached to a second end portion of the board member that is opposite the first end portion and that is perpendicular to and in between the side walls. An adjustable ruler having parallel flat elongated side walls, and opposite end portions adapted to be placed upon and engage respective the side walls of the board member, such that the ruler is in between and perpendicular to the board member side walls and forms a rectangular volume defined by its respective side wall, the side walls of the board member, and the mat holder, and that is adapted to receive and hold a quantity of rice and other sushi ingredients therein;

b), a rolling pin having a length greater than the distance between the side walls of the board member and adapted to roll back and forth along both the side walls to thereby remove excess rice and out of the cutting edges of the ruler and of the mat holder. The excess of rice falls down into the cradles along the side walls of the board and those of the ruler and the mat holder from the rectangular volume; and

c), an elongated holding and cutting member placed adjacent to the board member, the holding and cutting member including an elongated cradle portion and a measuring device, and is adapted to hold and aid in cutting a sushi roll into pieces after it has been made using the board member.

A preferred embodiment has each the board member side wall has an inner surface facing the rectangular volume, and an outer surface facing away from the rectangular volume, wherein the side wall outer surfaces have a series of corresponding pairs of notches formed at predetermined positions along the lengths thereof; and wherein the adjustable ruler end portions are adapted to releasably engage any chosen respective pairs of notches in order to define and form a predetermined rectangular volume.

Preferably, the adjustable ruler includes a sharp upper edge along a length that corresponds to the distance between the board member side walls; and wherein the pair of parallel elongated side walls each have a sharp upper edge along its length, such that the sharp upper edges of the adjustable ruler and the side walls and the sharp edge of the mat holder form a four-sided sharp upper edge shape; and wherein the rolling pin is adapted to roll upon and across the sharp edges to thereby force any excess rice a distance away from the rectangular volume.

In yet another preferred embodiment, the mat roller comprises a mat rolling member that is detachable from the handle portions, and is formed from two detachable linear holding sections, a first linear holding section including at least one connecting pin, and a second linear holding section including at least one corresponding connecting hole that is adapted to releasably hold the pin of the first linear holding section; and wherein the one end of the mat member being removably attached to the mat roller includes at least one punch hole that is adapted to be engaged by the at least one connecting pin of the first linear holding section, such that when the at least one punch hole is engaged by the at least one connecting pin, and the one connecting pin engages the corresponding at least one connecting hole the mat member is releasably and securely attached to the mat roller.

In yet another embodiment, the mat member opposite end includes at least one punch hole adapted to be removably attached to the second end portion of the board member; and wherein the second end portion of the board member further includes at least one engaging pin adapted removably hold the at least one punch hole of the mat member opposite end, and at least one holding cavity; and wherein the board member further includes an elongated mat holding member that includes at least one clip that is adapted to be releasably held by the at least one holding cavity of the board member, such that when the at least one punch hole of the mat member opposite end engages the at least one engaging pin of the second end portion of the board member, the at least one clip of the mat holding member is engaged with the at least one holding cavity of the board member, the mat member is releasably and securely attached to the second end portion of the board member.

Still in another embodiment, the measuring device of the holding and cutting member is positioned adjacent one end of the cradle portion and includes at least three edge surfaces; a first of the at least three edge surfaces extends perpendicularly upwards from the elongated dimension of the cradle portion and faces towards the cradle portion and is adapted to guide the movement of a sushi cutting knife, and wherein a second and third of the at least three edge surfaces also extends perpendicularly upwards from the elongated dimension of the cradle portion and faces away from the cradle portion, wherein the distance between the first and second edge surfaces form a first thickness, and the first and third edge surfaces form a second thickness, such that when a sushi roll is placed within the cradle portion, the sushi cutting knife can be placed against either the second or third edge surface depending on the desired thickness of sushi roll cuts, an adjacent end of the sushi roll is then pushed up against the sushi cutting knife and is ready for cutting by a user sliding the sushi cutting knife along and down the first edge surface.

Preferably, the holding and cutting member further includes a cutting notch placed adjacent the measuring device and through the cradle portion, such that when a knife is used to cut a sushi roll the knife can continue completely through the sushi roll an into the notch, thereby forming a clean and complete cut through the sushi roll.

The adjustable ruler end portions are formed as clips that are adapted to releasably and securely engage any chosen respective pairs of notches of the side wall outer surfaces.

The sushi mat roller includes a pair of spaced grooves that are adapted to respectively roll along the upper surfaces of the pair of parallel elongated side walls, and thereby aid in maintaining a uniformly thick sushi roll and prevents ingredients from spilling under the mat roller.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric views of the invention parts.

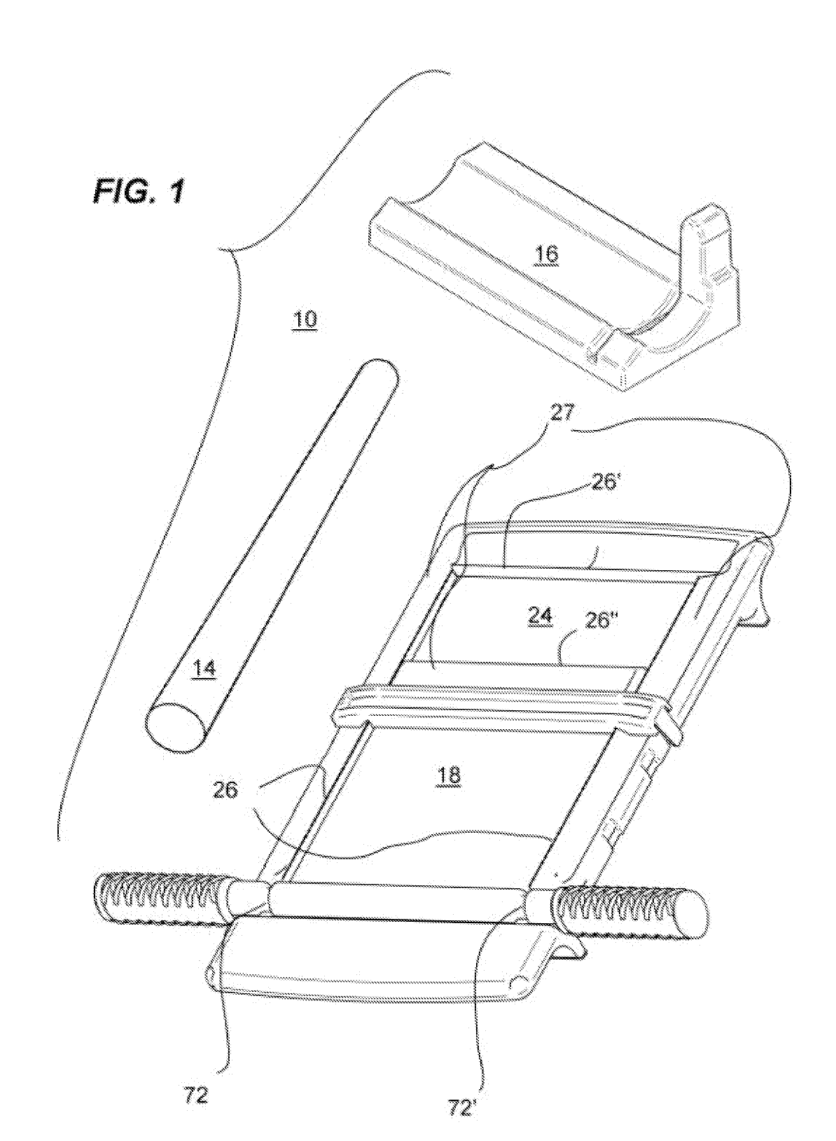

FIG. 2 Exploded view of the invention.

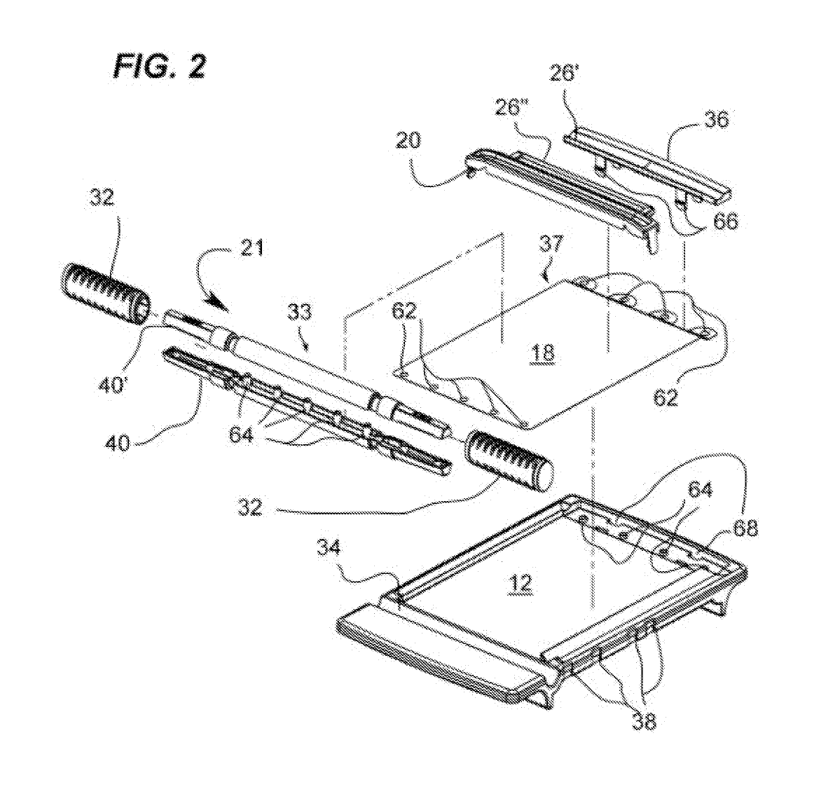

FIG. 3 Isometric view of the board.

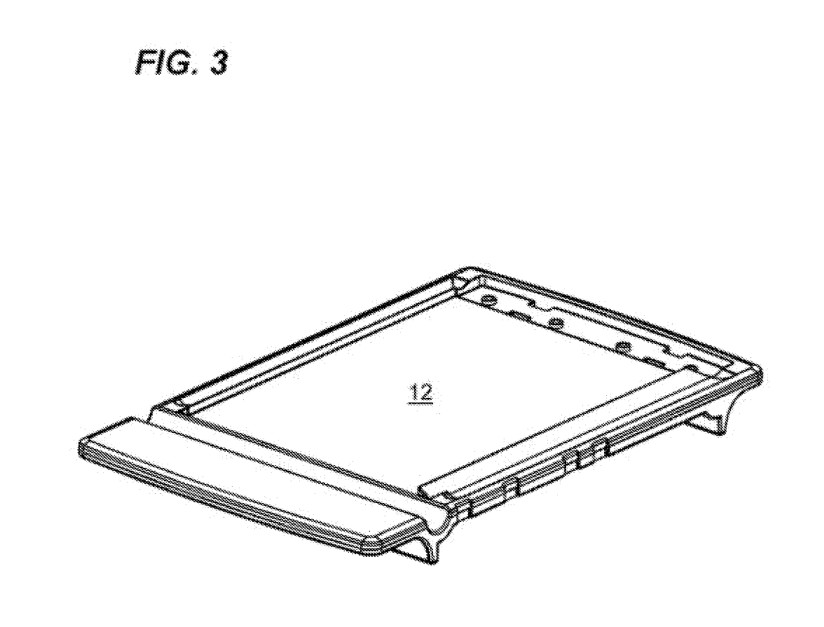

FIGS. 4a-b Isomeric and front views of the cutting apparatus.

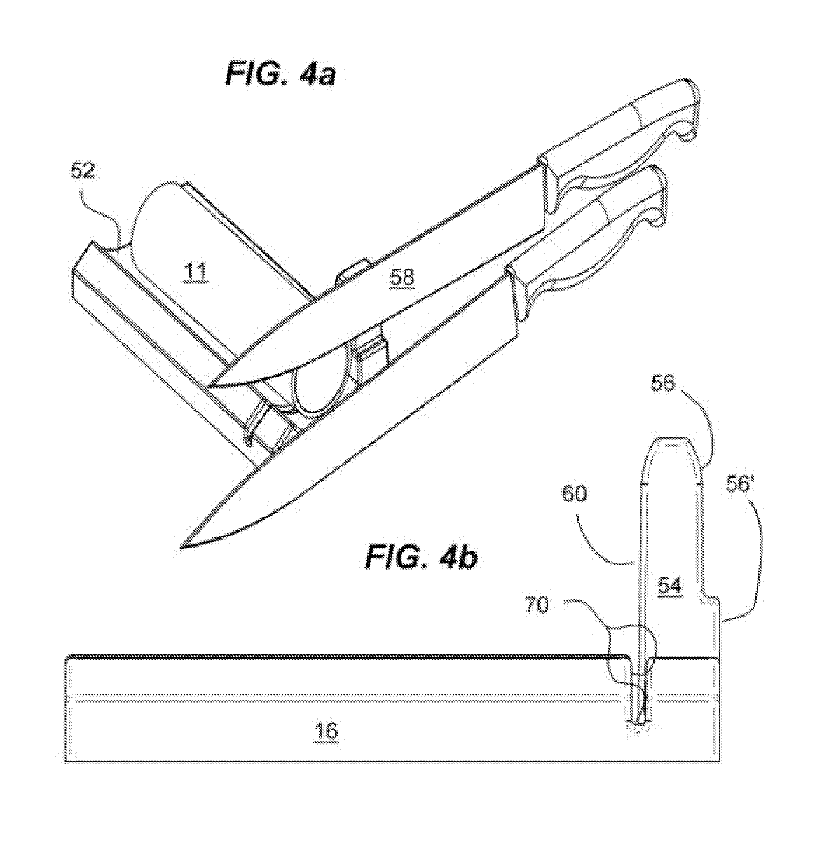

FIGS. 5a-d Isometric view of the measuring and cutting process of the cutting apparatus.

### DETAILED DESCRIPTION OF THE PREFERRED EMBODIMENT

A sushi making apparatus (10) has a board member (12), a rolling pin (14). A mat (18) used for forming a sushi strip (not shown). An adjustable ruler (20) used for measuring quantities. The ruler (20) can be moved along the length of the board (12) by clipping it to any corresponding pairs of notches (38).

The board (12) has a pair of sharp elongated side walls (26) running along its sides so as to neatly cut off and separate excess rice. The side walls also incorporate side wall cradles (27) to receive excess rice. The ruler (20) can be adjusted along the length of the mat (18) so as to determine the amount of sushi elements to be placed. The ruler also has a sharp edge (26″).

A mat roller (21) has a pair of handles (32), and at rest, has its mat holder member (33) resting in a cradle (34) that forms an integral part of one end of the board (12). The mat holder member (33) is split into two detachable linear holding sections (40,40′), a first linear holding section (40) including at least one connecting pin (64), and a second linear holding section (40′) including at least one corresponding connecting hole (not shown) that is adapted to releasably hold the pin (64) of the first linear holding section (40). The mat roller (21) includes a pair of spaced grooves (72, 72′) that are adapted to respectively roll along the upper surfaces of the pair of parallel elongated side walls (26), and thereby aid in maintaining a uniformly thick sushi roll (11) and preventing the ingredients from spilling under it. A mat's distal end (37) is releasably attached to a mat holding means (36) also by way of punch holes (62) engaging pins (64) extending perpendicularly from the board (12). The mat holding means (36) itself is releasably attached to the board (12) by way of clips (66) engaging cavities (68) and it also has a sharp edge (26′).

After an intended user (not shown) has rolled the sushi roll (11), it is taken from the board (12) and onto a cutting apparatus (16). The cutting apparatus (16) can be placed proximal to the board's (12) distal end.

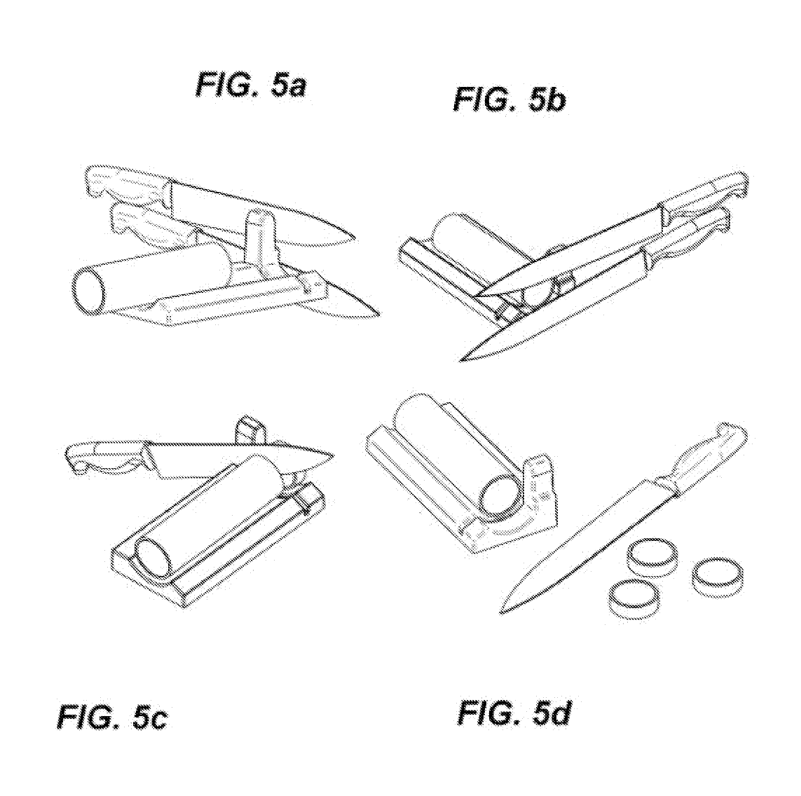

The sushi making apparatus (10) facilitates the making of sushi by combining various operations into a single device. The intended user puts the ruler (20) into a chosen pair of notches (38), depending upon the kind of maki intended to be made; Puts a quantity of rice onto the mat (18); The rice is spread and flattened onto the mat (18) using the rolling pin (14); A sheet of algae (not shown) is placed over the rice (not shown); The ruler is taken off before or after placing the sheet of algae. The rice and algae can be left in this order or flipped over and brought back along the sushi roller depending on whether the end result is to have the algae on the outside or the inside. The intended user puts in the various ingredients; Finally, the intended user tighten the ingredients by pulling the handles (32) against the ingredients, then takes the handles (32) and rolls the mat (18), by way of a countereclockwise movement of the handles (32), to roll the sushi (11) up to the end of the board (12); The rolled up sushi (11) is then taken to a cutting apparatus (16) which has a cutting cradle (52), a measuring device (54) having two preselected size template members (56, 56′) so as to cut the sushi (11) roll into any one of two possible widths by having the sushi (11) abut against the knife (58) which is placed against any one of the two preselected size template members (56, 56′), as per FIGS. 5a-b. Then, the knife (58) simply needs to cut along a knife guide (60), as per FIG. 5c, and all the way down into a cutting notch (70).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A sushi making apparatus comprising
a) a board member including a flat top surface, a pair of parallel elongated side walls, and an elongated cradle formed upon a first end portion perpendicular to said side walls; an elongated mat roller adapted to be placed within said cradle and having a length greater than the distance between said side walls, and handle portions formed upon opposite end portions that extend past said parallel side walls; a mat member adapted to be placed upon said top surface of said board member in between said parallel side walls, one end of said mat member being removably attached to said mat roller along a length of said roller that is adapted to fit in between said parallel side walls, and an opposite end being removably attached to a second end portion of said board member that is opposite said first end portion and that is perpendicular to and in between said side walls; and an adjustable ruler having parallel flat elongated side walls, and opposite end portions adapted to be placed upon and engage respective said side walls of said board member, such that said ruler is in between and perpendicular to said board member side walls and forms a rectangular volume defined by its respective side wall, said side walls of said board member, and said mat roller, and that is adapted to receive and hold a quantity of rice and other sushi ingredients therein;
b) a rolling pin having a length greater than said distance between said side walls of said board member and adapted to roll back and forth along both said side walls to thereby remove excess rice and out of said cutting edges of said ruler and of said mat holder. The excess of rice falling down into said cradles along said side walls of said board and said side walls of said ruler and said mat holder from said rectangular volume;
c) an elongated holding and cutting member placed adjacent to said board member, said holding and cutting member including an elongated cradle portion and a measuring device, and is adapted to hold and aid in cutting a sushi roll into pieces after it has been made using said board member.

2. The sushi making apparatus of claim 1, wherein each said board member side wall has an inner surface facing said rectangular volume, and an outer surface facing away from said rectangular volume, wherein said side wall outer surfaces have a series of corresponding pairs of notches formed at predetermined positions along the lengths thereof; and wherein said adjustable ruler end portions are adapted to releasably engage any chosen respective pairs of notches in order to define and form a predetermined rectangular volume.

3. The sushi making apparatus of claim 1, wherein said adjustable ruler includes a sharp upper edge along a length that corresponds to the distance between said board member side walls; and wherein said pair of parallel elongated side walls each have a sharp upper edge along its length, such that said sharp upper edges of said adjustable ruler and said side walls form a three-sided sharp upper edge shape; and wherein said rolling pin is adapted to roll upon and across said sharp edges to thereby force any excess rice a distance away from said rectangular volume.

4. The sushi making apparatus of claim 1, wherein said mat roller comprises a mat rolling member that is detachable from said handle portions, and is formed from two detachable linear holding sections, a first linear holding section including at least one connecting pin, and a second linear holding section including at least one corresponding connecting hole that is adapted to releasably hold said pin of said first linear holding section; and wherein said one end of said mat member being removably attached to said mat roller includes at least one punch hole that is adapted to be engaged by said at least one connecting pin of said first linear holding section, such that when said at least one punch hole is engaged by said at least one connecting pin, and said one connecting pin engages said corresponding at least one connecting hole said mat member is releasably and securely attached to said mat roller.

5. The sushi making apparatus of claim 1, wherein said mat member opposite end includes at least one punch hole adapted to be removably attached to said second end portion of said board member; and wherein said second end portion of said board member further includes at least one engaging pin adapted removably hold said at least one punch hole of said mat member opposite end, and at least one holding cavity; and wherein said board member further includes an elongated mat holding member that includes at least one clip that is adapted to be releasably held by said at least one holding cavity of said board member, such that when said at least one punch hole of said mat member opposite end engages said at least one engaging pin of said second end portion of said board member, said at least one clip of said mat holding member is engaged with said at least one holding cavity of said board member, said mat member is releasably and securely attached to said second end portion of said board member.

6. The sushi making apparatus of claim 1, wherein said measuring device of said holding and cutting member is positioned adjacent one end of said cradle portion and includes at least three edge surfaces; a first of said at least three edge surfaces extends perpendicularly upwards from the elongated dimension of said cradle portion and faces towards said cradle portion and is adapted to guide the movement of a sushi cutting knife, and wherein a second and third of said at least three edge surfaces also extends perpendicularly upwards from said elongated dimension of said cradle portion and faces away from said cradle portion, wherein the distance between said first and second edge surfaces form a first thickness, and said first and third edge surfaces form a second thickness, such that when a sushi roll is placed within said cradle portion, said sushi cutting knife can be placed against either said second or third edge surface depending on the desired thickness of sushi roll cuts, an adjacent end of said sushi roll is then pushed up against said sushi cutting knife and is ready for cutting by a user sliding said sushi cutting knife along and down said first edge surface.

7. The sushi making apparatus of claim 1, wherein said holding and cutting member further includes a cutting notch placed adjacent said measuring device and through said cradle portion, such that when a knife is used to cut a sushi roll said knife can continue completely through said sushi roll an into said notch, thereby forming a clean and complete cut through said sushi roll.

8. The sushi making apparatus of claim 2, wherein said adjustable ruler end portions are formed as clips that are adapted to releasably and securely engage any chosen respective pairs of notches of said side wall outer surfaces.

9. The sushi making apparatus of claim 1, wherein said mat roller includes a pair of spaced grooves that are adapted to respectively roll along the upper surfaces of said pair of parallel elongated side walls, and thereby aid in maintaining a uniformly thick sushi roll and prevents ingredients from spilling under said mat roller.

10. A method of making sushi comprising the steps of:
a. providing a board member including a flat top surface, a pair of parallel elongated side walls, and an elongated cradle formed upon a first end portion perpendicular to said side walls; an elongated mat roller adapted to be placed within said cradle and having a length greater than the distance between said side walls, and handle portions formed upon opposite end portions that extend past said parallel side walls; a mat member adapted to be placed upon said top surface of said board member in between said parallel side walls, one end of said mat member being removably attached to said mat roller along a length of said roller that is adapted to fit in between said parallel side walls, and an opposite end being removably attached to a second end portion of said board member that is opposite said first end portion and that is perpendicular to and in between said side walls; and an adjustable ruler having parallel flat elongated side walls, and opposite end portions adapted to be placed upon and engage respective said side walls of said board member, such that said ruler is in between and perpendicular to said board member side walls and forms a rectangular volume defined by its respective side wall, said side walls of said board member, and said mat roller, and that is adapted to receive and hold a quantity of rice and other sushi ingredients therein;
b) a rolling pin having a length greater than the distance between said side walls of said board member and adapted to roll back and forth along both said side walls to thereby remove excess rice and out of said cutting edges of said ruler and of said mat holder. The excess of rice falling down into said cradles along said side walls of said board and said side walls of said ruler and said mat holder from said rectangular volume;
c. providing a sushi cutting knife, and an elongated holding and cutting member placed adjacent to said board member, said holding and cutting member including an elongated cradle portion and a measuring device, and is adapted to hold and aid in cutting a sushi roll into smaller pieces after it has been made using said board member;
d. attaching said one end of said mat member to said mat roller;
e. attaching said opposite said mat member to said second end portion of said board member;
f. placing said mat roller in said cradle of said board member;
g. attach said adjustable ruler in a chosen position between said board member side walls forming a chosen rectangular volume;
h. placing a quantity of rice and other sushi ingredients within said rectangular volume;
i. using said rolling pin to level off said rice and other sushi ingredients, and push away an excess rice and other sushi ingredients;
j. removing said adjustable ruler from said board member side walls;
k. using said handle portions of said mat roller, rolling said mat roller along said board member side walls, and thereby rolling said mat member, to thereby roll said rice and other sushi ingredients into an elongated sushi roll;
l. removing said elongated sushi roll and placing it into said cradle portion of said holding and cutting member;
m. using said sushi cutting knife and said measuring device to cut predetermined thickness sushi roll cuts from said elongated sushi roll.

11. The method of claim 10, wherein each said board member side wall has an inner surface facing said rectangular volume, and an outer surface facing away from said rectangular volume, wherein said side wall outer surfaces have a series of corresponding pairs of notches formed at predetermined positions along the lengths thereof; and wherein said adjustable ruler end portions are adapted to releasably engage any chosen respective pairs of notches in order to define and form a predetermined rectangular volume.

12. The method of claim 10, wherein said adjustable ruler includes a sharp upper edge along a length that corresponds to the distance between said board member side walls; and wherein said pair of parallel elongated side walls each have a sharp upper edge along its length, such that said sharp upper edges of said adjustable ruler and said side walls form a three-sided sharp upper edge shape; and wherein said rolling pin is adapted to roll upon and across said sharp edges to thereby force any excess rice a distance away from said rectangular volume.

13. The method of claim 10, wherein said mat roller comprises a mat rolling member that is detachable from said handle portions, and is formed from two detachable linear holding sections, a first linear holding section including at least one connecting pin, and a second linear holding section including at least one corresponding connecting hole that is adapted to releasably hold said pin of said first linear holding section; and wherein said one end of said mat member being removably attached to said mat roller includes at least one punch hole that is adapted to be engaged by said at least one connecting pin of said first linear holding section, such that when said at least one punch hole is engaged by said at least one connecting pin, and said one connecting pin engages said corresponding at least one connecting hole said mat member is releasably and securely attached to said mat roller.

14. The method of claim 10, wherein said mat member opposite end includes at least one punch hole adapted to be removably attached to said second end portion of said board member; and wherein said second end portion of said board member further includes at least one engaging pin adapted removably hold said at least one punch hole of said mat member opposite end, and at least one holding cavity; and wherein said board member further includes an elongated mat holding member that includes at least one clip that is adapted to be releasably held by said at least one holding cavity of said board member, such that when said at least one punch hole of said mat member opposite end engages said at least one engaging pin of said second end portion of said board member, said at least one clip of said mat holding member is engaged with said at least one holding cavity of said board member, said mat member is releasably and securely attached to said second end portion of said board member.

15. The method of claim 10, wherein said measuring device of said holding and cutting member is positioned adjacent one end of said cradle portion and includes at least three edge surfaces; a first of said at least three edge surfaces extends perpendicularly upwards from the elongated dimension of said cradle portion and faces towards said cradle portion and is adapted to guide the movement of a sushi cutting knife, and wherein a second and third of said at least three edge surfaces also extends perpendicularly upwards from said elongated dimension of said cradle portion and faces away from said cradle portion, wherein the distance between said first and second edge surfaces form a first thickness, and said first and third edge surfaces form a second thickness, such that when a sushi roll is placed within said cradle portion, said sushi cutting knife can be placed against either said second or third edge surface depending on the desired thickness of sushi roll cuts, an adjacent end of said sushi roll is then pushed up against said sushi cutting knife and is ready for cutting by a user sliding said sushi cutting knife along and down said first edge surface.

16. The method of claim 10, wherein said holding and cutting member further includes a cutting notch placed adjacent said measuring device and through said cradle portion, such that when a knife is used to cut a sushi roll said knife can continue completely through said sushi roll an into said notch, thereby forming a clean and complete cut through said sushi roll.

17. The method of claim 11, wherein said adjustable ruler end portions are formed as clips that are adapted to releasably and securely engage any chosen respective pairs of notches of said side wall outer surfaces.

18. The method of claim 10, wherein said mat roller includes a pair of spaced grooves that are adapted to respectively roll along said upper surfaces of said pair of parallel elongated side walls, and thereby aid in maintaining a uniformly thick sushi roll and prevents ingredients from spilling under said mat roller.
